(19) United States
(12) Patent Application Publication
(10) Pub. No.: US 2020/0301746 A1
(43) Pub. Date: Sep. 24, 2020

(54) INFORMATION PROCESSING APPARATUS AND INFORMATION PROCESSING SYSTEM

(71) Applicant: FUJITSU CLIENT COMPUTING LIMITED, Kanagawa (JP)

(72) Inventor: Junya Kanaami, Kawasaki (JP)

(73) Assignee: FUJITSU CLIENT COMPUTING LIMITED, Kanagawa (JP)

(21) Appl. No.: 16/750,651

(22) Filed: Jan. 23, 2020

(30) Foreign Application Priority Data
Mar. 19, 2019 (JP) 2019-051572

(51) Int. Cl. G06F 9/50; G06F 13/10

(52) U.S. Cl. CPC G06F 9/5072; G06F 13/102

(57) ABSTRACT

An information processing apparatus is connected to processing apparatuses over a bus. The information processing apparatus includes: a memory and a hardware processor coupled to the memory. The hardware processor: individually transfers data to the processing apparatuses over the bus based on transfer parameters for transfer, each of the transfer parameters is set for each of the processing apparatuses; acquires respective processing results of processing executed based on the data by the processing apparatuses; and adjusts, for each of the processing apparatuses, the transfer parameter based on the corresponding processing result.

### CROSS-REFERENCE TO RELATED APPLICATIONS

This application is based upon and claims the benefit of priority from Japanese Patent Application No. 2019-051572, filed Mar. 19, 2019, the entire contents of which are incorporated herein by reference.

### FIELD

Embodiments described herein relate to an information processing apparatus and an information processing system.

### BACKGROUND

Conventionally, a distributed computer including a plurality of platforms has been known. The distributed computer is directed to a speedup in processing by distributing the processing among processing apparatuses such as platforms.

When the processing apparatuses execute respective processing in such a distributed computer, efficiency of data transfer to the processing apparatuses largely affects the processing time of the distributed computer as a whole.

However, the distributed computer executes various kinds of processing, so that it is difficult to enhance the efficiency of data transfer.

### SUMMARY

An information processing apparatus according to a first aspect of the present disclosure is connected to processing apparatuses over a bus. The information processing apparatus includes a memory and a hardware processor coupled to the memory. The hardware processor is configured to: individually transfer data to the processing apparatuses over the bus based on transfer parameters for transfer, each of the transfer parameters being set for each of the processing apparatuses; acquire respective processing results of processing executed based on the data by the processing apparatuses; and adjust, for each of the processing apparatuses, the transfer parameter based on the corresponding processing result.

An information processing system according to a second aspect of the present disclosure includes an information processing apparatus and processing apparatuses connected to the information processing apparatus over a bus. The information processing apparatus includes a memory and a hardware processor coupled to the memory. The hardware processor is configured to: individually transfer data to the processing apparatuses over the bus based on transfer parameters for transfer, each of the transfer parameters being set for each of the processing apparatuses; acquire respective processing results of processing executed based on the data by the processing apparatuses; and adjust, for each of the processing apparatuses, the transfer parameter based on the corresponding processing result. Each of the processing apparatuses includes a memory and a hardware processor coupled to the memory. The hardware processor is configured to receive the data from the information processing apparatus over the bus and execute, based on the received data, processing requested by the received data.

### BRIEF DESCRIPTION OF THE DRAWINGS

FIG. 1 is a block diagram illustrating an example of a configuration of a distributed computer according to an embodiment;

FIG. 2 is a diagram illustrating an example of an entire configuration of the distributed computer according to the embodiment;

FIG. 3 is a block diagram illustrating an example of a hardware configuration of a platform according to the embodiment;

FIG. 4 is a block diagram illustrating an example of a functional configuration of the distributed computer according to the embodiment;

FIG. 5 is a diagram for explaining an example of a transfer parameter adjustment procedure in human detection processing;

FIG. 6 is a flowchart illustrating an example of adjustment processing to be executed by a platform (host) according to the embodiment; and

FIG. 7 is a flowchart illustrating an example of execution processing to be executed by each platform (guest) according to the embodiment.

### DETAILED DESCRIPTION

The information processing apparatus and the information processing system according to the present disclosure are each capable of efficiently transferring data to a plurality of processing apparatuses.

The following describes embodiments of an information processing apparatus and an information processing system according to the present disclosure in detail based on the drawings. The following embodiments are not intended to limit the present disclosure.

### First Embodiment

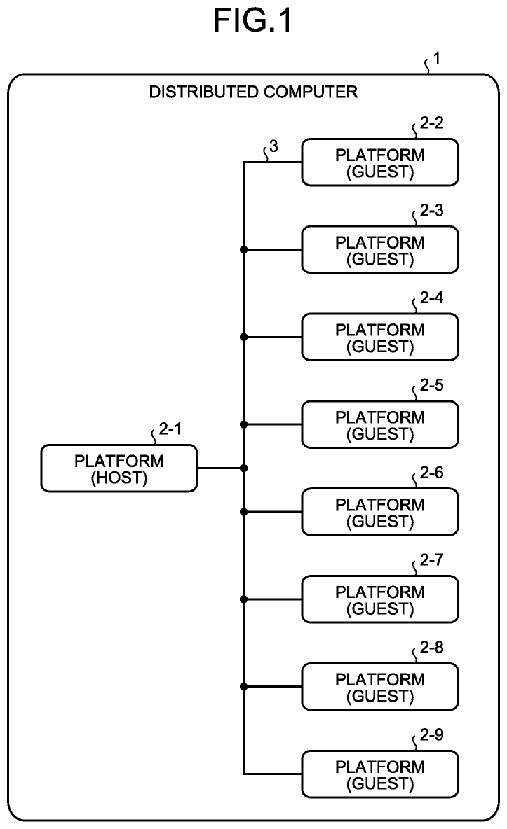

FIG. 1 is a block diagram illustrating an example of an embodiment of the configuration of a distributed computer 1 according to an embodiment. The distributed computer 1 is an information processing system in which a platform (host) 2-1 and a plurality of platforms (guest) 2-2 to 2-9 are connected to one another over a bus 3. The platform (host) 2-1 is an information processing apparatus that requests the platforms (guests) 2-2 to 2-9 to execute various kinds of processing. The platforms (guests) 2-2 to 2-9 are processing apparatuses that execute various kinds of processing in response to the request from the platform (host) 2-1.

The bus 3 is formed of a virtual local area network (LAN) for which peripheral component interconnect express (PCIe) (registered trademark) or the like is used. The bus 3 connects the platform (host) 2-1 and a plurality of platforms (guests) 2-2 to 2-9 so that the platform (host) 2-1 and a plurality of platforms (guests) 2-2 to 2-9 can communicate with one another. The bus 3 is not limited to being formed of the virtual LAN for which PCIe is used and may be formed of another communication interface such as a universal serial bus (USB).

In the distributed computer 1, the platform (host) 2-1 transfers, based on transfer parameters, data representing a request for executing various kinds of processing. Upon receiving the data, each of the platforms (guests) 2-2 to 2-9 executes processing requested by the data. When the platforms (guests) 2-2 to 2-9 have executed processing, the platform (host) 2-1 acquires results of the processing, including processing times, from the platforms (guests) 2-2 to 2-9. Additionally, the platform (host) 2-1 adjusts the transfer parameters based on the processing results. When transferring data representing the request for executing various kinds of processing, the platform (host) 2-1 transfers the data based on the adjusted transfer parameters.

As described above, the platform (host) 2-1 repeats the transfer of data based on the transfer parameters and the adjustment of the transfer parameters based on the processing results, thereby optimizing processing of the distributed computer 1 as a whole. That is, the platform (host) 2-1 efficiently transfers data to the platforms (guests) 2-2 to 2-9.

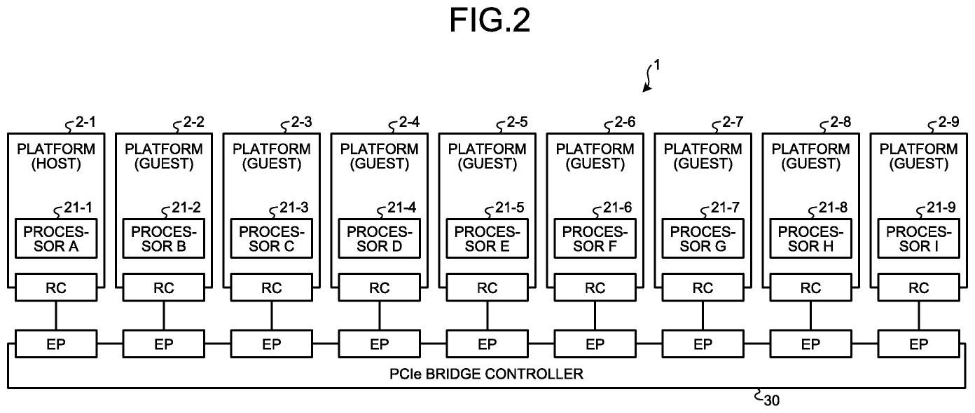

FIG. 2 is a diagram illustrating an example of the entire configuration of the distributed computer 1 according to the embodiment. As illustrated in FIG. 2, the distributed computer 1 according to the embodiment includes the platform (host) 2-1, the platforms (guests) 2-2 to 2-9, and a PCIe bridge controller 30.

The platform (host) 2-1 and a plurality of platforms (guests) 2-2 to 2-9 are connected to one another so as to communicate with one another via the PCIe bridge controller 30. The platform (host) 2-1 and the platforms (guests) 2-2 to 2-9 may be inserted into, for example, slots on a circuit board on which the PCIe bridge controller 30 is provided. A plurality of slots may include any slot that is in an empty state, that is, does not have a node inserted therein. In the following description, the term “platform 2” refers to any of the platforms 2-1 to 2-9 when there is no need to distinguish the platform (host) 2-1 and the platforms (guests) 2-2 to 2-9 from one another.

The platform (host) 2-1 causes the platforms (guests) 2-2 to 2-9 to execute various kinds of processing. The platform (host) 2-1 acquires results of the processing executed by the platforms (guests) 2-2 to 2-9. Examples of the result of the processing include a processing time taken for the processing. Subsequently, based on the results of the processing, the platform (host) 2-1 then adjusts transfer parameters to be used for transferring data.

The platforms (guests) 2-2 to 2-9 execute various kinds of processing based on data transferred from the platform (host) 2-1. The platforms (guests) 2-2 to 2-9 measure respective processing times taken for executing the processing.

The platforms 2 include respective processors 21-1 to 21-9. The processors 21-1 to 21-9 have respective dedicated functions. Note that the processors 21-1 to 21-9 may be provided by different manufacturers or may be provided by the same manufacturer. In the following description, the term “processor 21” refers to any of the processors 21-1 to 21-9 when there is no need to distinguish the processors 21-1 to 21-9 from one another.

The processors 21 serve as root complexes (RC) that function as hosts, and devices mounted on the PCIe bridge controller 30 serve as end points (EPs). Data is transferred between the hosts and the devices.

The PCIe bridge controller 30 executes data transfer between the EPs by controlling the bus 3 provided inside the PCIe bridge controller 30. That is, the PCIe bridge controller 30 executes communication between the platforms 2.

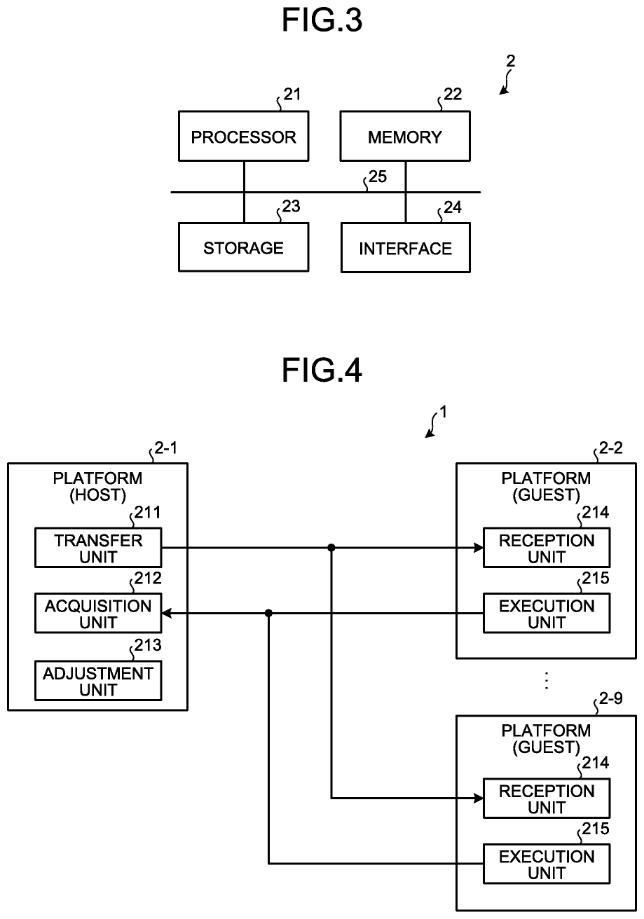

FIG. 3 is a block diagram illustrating an example of the hardware configuration of the platform 2 according to the embodiment.

The platform 2 includes the processor 21 (a hardware processor), a memory 22, storage 23, and an interface 24. The processor 21 executes various kinds of arithmetic processing. The memory 22 temporarily stores various kinds of information. The storage 23 stores various kinds of information. These components are connected to an internal bus 25.

The processor 21 controls the entire platform 2. The processor 21 may be a multiprocessor. For example, any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA) is used as the processor 21. Alternatively, the processor 21 may be a combination of at least two or more of the CPU, the MPU, the GPU, the DSP, the ASIC, the PLD, and the FPGA.

The memory 22 is a storage memory that includes a read only memory (ROM) and a random access memory (RAM). Various software programs and data for these software programs are written in the ROM of the memory 22. Each of the software programs on the memory 22 is read and executed by the processor 21 as appropriate. The RAM of the memory 22 is used as a primary storage memory or a working memory.

The storage 23 stores various kinds of data and is a storage device such as a hard disk drive (HDD), a solid state drive (SSD), and a storage class memory (SCM). Various software programs are stored in the storage 23.

In the platform 2, the processor 21 implements various functions by executing the software programs stored in the memory 22 or the storage 23.

The various software programs described above do not need to be stored in the memory 22 or the storage 23. For example, a software program stored in a storage medium, which can be read by the platform 2, may be read and executed by the platform 2. Examples of the storage medium include a portable recording medium, such as a compact disc read only memory (CD-ROM), digital versatile disc (DVD), or a USB memory, a semiconductor memory such as a flash memory, and a hard disk drive. Alternatively, an information processing program may be stored in an apparatus connected to a public line, the Internet, LAN, or the like to be read from the apparatus and be executed by the platform 2.

The interface 24 is an interface that connects to the bus 3.

Hardware included in the platform 2 is not limited to the hardware described above and may be other hardware. For example, the platform (host) 2-1 may include hardware such as an interface that connects to an input device for receiving various operations or an interface connected to a display device on which various screens are displayed.

FIG. 4 is a block diagram illustrating an example of the functional configuration of the distributed computer 1 according to the embodiment. The functions of the platform (host) 2-1 illustrated in FIG. 4 are implemented as results of readout and execution of software programs stored in the corresponding memory 22 by the processor 21-1. The functions of the platforms (guests) 2-2 to 2-9 illustrated in FIG. 4 are implemented as results of readout and execution of software programs stored in the corresponding memories 22 by the processors 21-2 to 21-9.

The platform (host) 2-1 includes a transfer unit 211, an acquisition unit 212, and an adjustment unit 213.

The transfer unit 211 individually transfers data to the platforms (guests) 2-2 to 2-9 over the bus 3 based on transfer parameters for the transfer, each having been set for each of the platforms (guests) 2-2 to 2-9. Each of the transfer parameter may be a set of one or more parameters that includes, for example, a processing accuracy parameter, a processing speed parameter, and/or a compression level parameter.

The processing accuracy parameter is a parameter that specifies the level of accuracy with which each of the platforms (guests) 2-2 to 2-9 is caused to execute processing. In the present embodiment, it is assumed that the processing is executed by the platforms (guests) 2-2 to 2-9 to detect a human from an image. In the case of human detection processing, the processing accuracy parameter is, for example, a parameter that specifies a resolution of an image. The transfer unit 211 converts an image into one with a resolution specified by the processing accuracy parameter and then transfers the image. When the resolution of an image is reduced, the accuracy with which each of the platforms (guests) 2-2 to 2-9 detects a human is deteriorated. On the other hand, when the resolution of an image is reduced, the number of pixels on which the processing is executed is reduced, so that a processing time for the human detection processing becomes shorter. In some cases, while part of the platforms (guests), for instance, the platform (guest) 2-2, has sufficient processing accuracy but a long processing time, the other platforms (guests) 2-3 to 2-9 are kept waiting. In such a case, the transfer unit 211 transfers an image whose resolution has been reduced to the platform (guest) 2-2 having sufficient processing accuracy, thereby optimizing the processing of the distributed computer 1 as a whole.

The processing speed parameter is a parameter that specifies the transfer speed of data to each of the platforms (guests) 2-2 to 2-9. Examples of the processing speed parameter include the percentage of data packets to be transferred, and the occupancy rate in the bus 3. For example, the transfer unit 211 increases the percentage of data packets to be transferred to any of the platforms (guests) 2-2 to 2-9, whose processing time is relatively long, whereas it decreases the percentage of data packets to be transferred to any other of the platforms (guests) 2-2 to 2-9, whose processing time is relatively short. By the processing above, the transfer unit 211 optimizes the processing of the distributed computer 1 as a whole.

The compression level parameter is a parameter that specifies the compression ratio of data to be transferred to each of the platforms (guests) 2-2 to 2-9. For example, the transfer unit 211 performs transfer of data that has been compressed with a reduced compression ratio to any of the platforms (guests) 2-2 to 2-9, which takes relatively long time to decompress the compressed data. Consequently, the decompression time in the corresponding platform (guest) can be reduced.

Additionally, the transfer unit 211 performs transfer of data that has been compressed with an increased compression ratio to any of the platforms (guests) 2-2 to 2-9, which takes relatively long time to have data transferred thereto. Consequently, since the data size is reduced, the transfer unit 211 can shorten the time taken for transferring data.

The acquisition unit 212 acquires results of the processing executed by the platforms (guests) 2-2 to 2-9 based on the data. Specifically, the acquisition unit 212 acquires, from the platforms (guests) 2-2 to 2-9, respective processing times taken for executing the processing.

The adjustment unit 213 adjusts, for each of the platforms (guests) 2-2 to 2-9, the transfer parameters on the basis of the processing results acquired by the acquisition unit 212. More specifically, based on the processing result and the difference between the processing result and the corresponding target value, the adjustment unit 213 adjusts the transfer parameter for each of the platforms (guests) 2-2 to 2-9. The target value herein represents a processing time that is set as a target time for finishing the processing. The adjustment unit 213 adjusts the transfer parameter for each of the platforms (guests) 2-2 to 2-9 when the difference between the processing time represented by the corresponding processing result acquired by the acquisition unit 212 and the target value therefor is equal to or larger than a given threshold.

For example, when any of the platforms (guests) 2-2 to 2-9, whose difference between the processing time and the target value is equal to or larger than the threshold, is detected, the adjustment unit 213 adjusts, for each of the platforms (guests) 2-2 to 2-9, the transfer parameter such that the difference between the processing time and the target value of the detected platform (guest) becomes smaller. More specifically, the adjustment unit 213 adjusts the transfer parameters of the platforms (guests) 2-2 to 2-9 so as to increase the processing load on each platform (guest) whose difference between the processing time and the target value is relatively small, and decrease the processing load on each platform (guest) whose difference between the processing time and the target value is relatively large. In addition, the adjustment unit 213 decreases the transfer speed to each platform (guest) whose processing time is relatively short, and increases the transfer speed to each platform (guest) whose processing time is relatively long. By the processing above, the adjustment unit 213 optimizes the processing of the distributed computer 1 as a whole. Alternatively, the adjustment unit 213 may adjust, without any threshold, the transfer parameters at the time when the processing time is equal to or larger than the target value. Furthermore, the target value may be a value that is set for each kind of processing or may be a specific value that is uniformly set regardless of the kind of processing.

Further alternatively, the adjustment unit 213 may adjust, for each of the platforms (guests) 2-2 to 2-9, the transfer parameter based on a difference between the average of the respective processing results from the platforms (guests) 2-2 to 2-9 and a target value. In this case, the adjustment unit 213 may adjust, for each of the platforms (guests) 2-2 to 2-9, the transfer parameter when the difference between the average of the respective processing times taken in the platforms (guests) 2-2 to 2-9 and the target value is equal to or larger than a threshold. Also in this case, the adjustment unit 213 may adjust, without any threshold, the transfer parameters when the average of the respective processing times is equal to or larger than the target value.

Alternatively, the adjustment unit 213 may adjust the transfer parameters without any target value. In this case, for example, the adjustment unit 213 may compare the respective processing times of the platforms (guests) 2-2 to 2-9 with one another and determine whether there is any of the platforms (guests) whose processing time differs from that of any other of the platforms (guests) by a threshold value.

The adjustment unit 213 may adjust, for each of the platforms (guests) 2-2 to 2-9, one or more parameters included in the transfer parameters. That is, the adjustment unit 213 may adjust, for each of the platforms (guests) 2-2 to 2-9, the processing accuracy parameter, the processing speed parameter, and the compression level parameter included in the transfer parameter used for data transfer to the corresponding platform (guest). Consequently, the adjustment unit 213 can adjust the transfer parameter based on the conditions of each of the platforms (guests) 2-2 to 2-9.

In some cases, the platforms (guests) 2-2 to 2-9 become unable to execute processing due to change in the transfer parameters by the adjustment unit 213. Such a case is described here by using an example of processing in which a human is detected from an image. It is assumed that, since one of the platforms (guests) 2-2 to 2-9, for instance, the platform (guest) 2-2, takes a long processing time, the adjustment unit 213 reduces the corresponding processing accuracy parameter, more specifically, the corresponding resolution of an image. However, when the adjustment unit 213 excessively reduces the resolution, the platform (guest) 2-2 becomes unable to detect a human. In such a case, the platform (guest) 2-2 determines that the human detection processing is not executable and then outputs a processing result representing an error of the processing. Then, the acquisition unit 212 acquires, from the platform (guest) 2-2, the processing result representing that the processing has not been able to be executed due to the change in value of the transfer parameter.

Subsequently, based on the processing results acquired by the acquisition unit 212, the adjustment unit 213 adjusts the transfer parameter for each of the platforms (guests) 2-2 to 2-9. For example, the adjustment unit 213 turns back, to the value before the adjustment, the transfer parameter used for the above-mentioned platform (guest) 2-2 that has been unable to execute the processing due to the change in value of the transfer parameter. That is, in the case of processing for detecting a human from an image, the adjustment unit 213 increases the corresponding resolution of an image to be transferred to the platform (guest) 2-2. Consequently, the platform (guest) 2-2 becomes able to execute the unexecuted processing.

Returning to FIG. 4, each of the platforms (guests) 2-2 to 2-9 includes a reception unit 214 and an execution unit 215.

The reception unit 214 receives data from the platform (host) 2-1 over the bus 3. That is, the reception unit 214 receives data representing a request of executing various kinds of processing.

Based on the data received by the reception unit 214, the execution unit 215 executes the processing requested by the data. The execution unit 215 outputs the processing result of the processing requested by the data. That is, the execution unit 215 outputs a processing time taken to finish the processing requested by the data. Optionally, the execution unit 215 may output the processing result that represents processing times for each individual item of processing. In this case, the execution unit 215 may output the processing result that represents respective processing times to be taken for: data transfer between the start from data transfer and the completion of data reception; data decompression for decompressing received data; and execution processing for executing processing requested by data. Consequently, the platform (host) 2-1 can obtain information on processing times taken for each individual item of processing. Thus, the platform (host) 2-1 becomes able to determine which parameter among the transfer parameters needs to be adjusted.

In some cases, as described above, the execution unit 215 becomes unable to execute processing due to change in value for the transfer parameter. In such a case, the execution unit 215 outputs the processing result that represents an error.

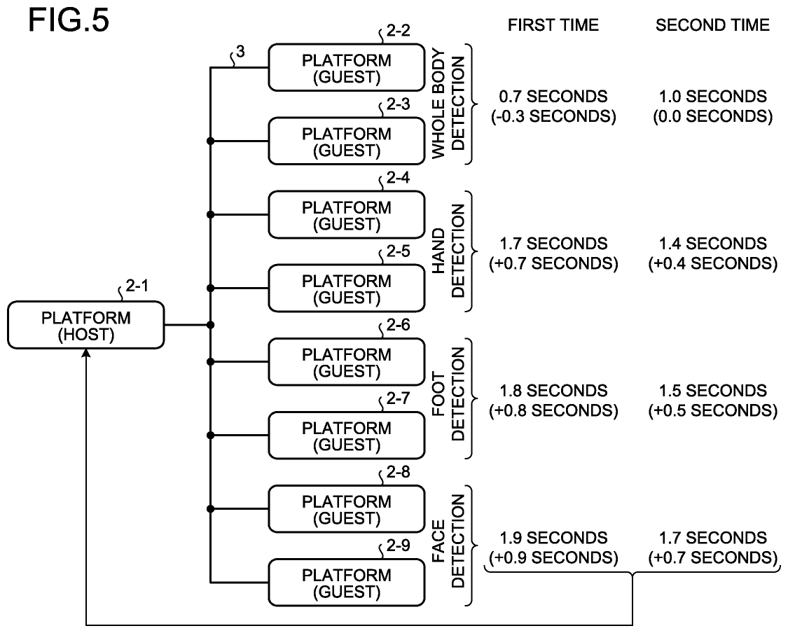

Next, processing for adjusting the transfer parameters will be described with referring to an example of processing in which a human is detected from an image. FIG. 5 is a diagram for explaining an example of a transfer parameter adjustment procedure in human detection processing.

In FIG. 5, the platform (guest) 2-2 and the platform (guest) 2-3 each execute whole body detection processing for detecting a whole body. The platform (guest) 2-4 and the platform (guest) 2-5 each execute hand detection processing for detecting a hand or hands. The platform (guest) 2-6 and the platform (guest) 2-7 each execute foot detection processing for detecting a foot or feet. The platform (guest) 2-8 and the platform (guest) 2-9 each execute face detection processing for detecting a face. It is assumed here that the target values for the whole body detection processing, the hand detection processing, the foot detection processing, and the face detection processing are each set to 1 second, which is the average of the times taken for those processing.

It is also assumed that, as illustrated in FIG. 5, respective processing times in the first round of these kinds of processing executed under the above conditions are: 0.7 seconds for the whole body detection processing; 1.7 seconds for the hand detection processing; 1.8 seconds for the foot detection processing; and 1.9 seconds for the face detection processing. It is further assumed that the threshold is 0.2 seconds. In this case, since the difference between the average of the processing times and the target value (1 second) is larger than the threshold, the adjustment unit 213 adjusts the transfer parameter for each of the platforms (guests) 2-2 to 2-9.

For example, the adjustment unit 213 finds that the processing time for whole body detection processing is 0.7 seconds that is lower than the target value. Then, the adjustment unit 213 adjusts, for example, the processing speed parameters for the platforms (guests) 2-2 to 2-3 to decrease the transfer speeds thereto. At the same time, the adjustment unit 213 adjusts the processing speed parameters for the other platforms (guests) 2-4 to 2-9 to increase the transfer speeds.

With regard to the hand detection processing and the foot detection processing, it is assumed that they can be executed with sufficient levels of processing accuracy. However, the processing times are 1.7 seconds for the hand detection processing and 1.8 seconds for the foot detection processing. That is, the difference between the average of the processing times for the hand detection processing and the target value and the difference between the average of the processing times for the foot detection processing and the target value are both larger than the threshold. The adjustment unit 213 then adjusts, for example, the processing accuracy parameters for the platforms (guests) 2-4 to 2-7 to reduce the processing accuracy.

With regard to the face detection processing, it is assumed that data decomposition takes a long time. In this case, the adjustment unit 213 adjusts the compression level parameters for the platforms (guests) 2-8 to 2-9 to reduce the compression ratios.

Subsequently, the distributed computer 1 executes the second round of the processing. That is, the transfer unit 211 transfers data to the platforms (guests) 2-2 to 2-9 by using the transfer parameters that have been adjusted by the adjustment unit 213. The acquisition unit 212 acquires the processing results from the platforms (guests) 2-2 to 2-9. As a result, the processing times are improved in the second round of the processing as illustrated in FIG. 5.

The platform (host) 2-1 causes each difference between each processing time and the target value to become less than the threshold by repeatedly executing the above-described processing. Consequently, the platform (host) 2-1 optimizes the processing of the distributed computer 1 as a whole. The adjustment unit 213 may determine, based on the processing results acquired by the acquisition unit 212, one or more of the transfer parameters are to be adjusted and the levels of adjustment to be applied to the transfer parameters as described above, or may randomly determine one or more of the transfer parameters that are to be adjusted and the levels of adjustment to be applied to the transfer parameters.

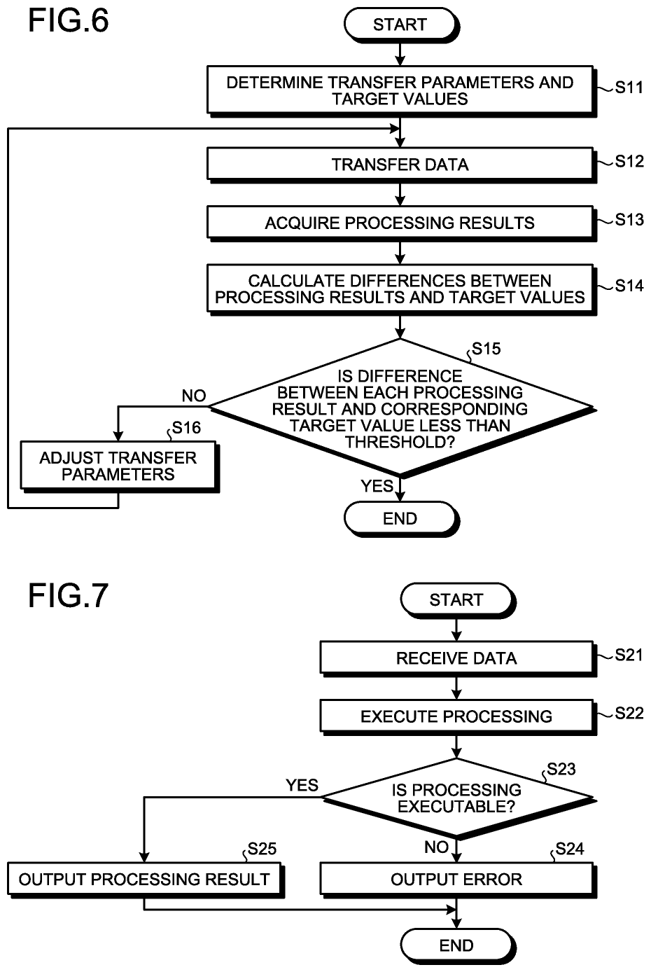

Next, the transfer parameter adjustment processing by the platform (host) 2-1 will be described with referring to a flowchart. FIG. 6 is the flowchart illustrating an example of the adjustment processing to be executed by the platform (host) 2-1 according to the embodiment.

The adjustment unit 213 determines initial values for the transfer parameters and the target values (step S11). The initial values may be previously set or may be calculated based on details of the processing or the like.

The transfer unit 211 transfers data to the platforms (guests) 2-2 to 2-9 over the bus 3 based on transfer parameters for the transfer, each having been set for each of the platforms (guests) 2-2 to 2-9 (step S12).

The acquisition unit 212 acquires respective processing results from the platforms (guests) 2-2 to 2-9 (step S13). That is, the acquisition unit 212 acquires processing times.

The adjustment unit 213 calculates the differences between the processing times represented by the processing results and the corresponding target values (step S14).

The adjustment unit 213 determines whether each of the differences between the processing times represented by the processing results and the corresponding target values is equal to or less than a threshold (step S15).

When any of the differences between the processing times represented by the processing results and the corresponding target values is equal to or larger than the threshold (No at step S15), the adjustment unit 213 adjusts the transfer parameters (step S16). Subsequently, at step S12, the transfer unit 211 transfers data by using the adjusted transfer parameters.

When each of the differences between the processing times represented by the processing results and the corresponding target values is less than the threshold (Yes at step S15), the platform (host) 2-1 terminates the adjustment processing.

Next, the execution processing by each of the platforms (guests) 2-2 to 2-9 based on data transferred thereto will be described with referring to a flowchart. FIG. 7 is the flowchart illustrating an example of execution processing to be executed by each of the platforms (guests) 2-2 to 2-9 according to the embodiment.

The reception unit 214 receives data from the platform (host) 2-1 over the bus 3 (step S21).

Based on the data received by the reception unit 214, the execution unit 215 executes the processing requested by the data (step S22).

The execution unit 215 determines whether the processing based on the data received by the reception unit 214 is executable (step S23).

When the processing based on the data received by the reception unit 214 is not executable (No at step S23), the execution unit 215 outputs a processing result including an error representing the inexecutable state (step S24).

On the other hand, when the processing based on the data received by the reception unit 214 is executable (Yes at step S23), the execution unit 215 outputs a processing result including a processing time taken for the executed processing (step S25).

Then, the execution processing of each platform (guest) is terminated. As described above, according to the present embodiment, the platform (host) 2-1 individually transfers data to the platforms (guests) 2-2 to 2-9 over the bus 3 based on transfer parameters set for each of the platforms (guests) 2-2 to 2-9. When the platforms (guests) 2-2 to 2-9 have executed processing based on the data, the platform (host) 2-1 acquires their respective processing results, each representing a processing time. The platform (host) 2-1 then adjusts the transfer parameter for each of the platforms (guests) 2-2 to 2-9 based on the processing results. The platform (host) 2-1 repeatedly executes the above-described processing until the processing times are uniform among the platforms (guests) 2-2 to 2-9. That is, the platform (host) 2-1 repeatedly executes the above-described processing until there is no wasted time in data transfer. Consequently, the platform (host) 2-1 can efficiently transfer individual data to the platforms (guests) 2-2 to 2-9.

More specifically, based on the difference between the processing result and the corresponding target value for the processing result, the adjustment unit 213 in the platform (host) 2-1 according to the present embodiment adjusts the transfer parameter for each of the platforms (guests) 2-2 to 2-9. The target value is set by a user. Consequently, the platform (host) 2-1 can adjust each individual transfer parameter until the processing time of the corresponding platform (guest) meets the target value desired by the user.

The adjustment unit 213 in the platform (host) 2-1 adjusts, for each of the platforms (guests) 2-2 to 2-9, one or more parameters (a set of parameters) included in the transfer parameter. Consequently, the adjustment unit 213 can adjust the transfer parameter based on the condition of each of the platforms (guests) 2-2 to 2-9.

When any of the platforms (guests) 2-2 to 2-9 has been unable to execute the processing, the acquisition unit 212 in the platform (host) 2-1 acquires the processing result representing an error. Subsequently, based on the processing results acquired by the acquisition unit 212, the adjustment unit 213 adjusts the transfer parameter for each of the platforms (guests) 2-2 to 2-9. Consequently, even when having failed to adjust the transfer parameters and have not been able to have the processing executed, the adjustment unit 213 can still adjust the transfer parameters.

The distributed computer 1 according to the present embodiment is an information processing system in which the platform (host) 2-1 and the platforms (guests) 2-2 to 2-9 are connected to each other over the bus 3. The platform (host) 2-1 includes the transfer unit 211, the acquisition unit 212, and the adjustment unit 213. The transfer unit 211 transfers data to the platforms (guests) 2-2 to 2-9 over the bus 3 based on the transfer parameter for transfer that is set for each of the platforms (guests) 2-2 to 2-9. The acquisition unit 212 acquires results of the processing executed by the platforms (guests) 2-2 to 2-9 based on the data. Based on the processing results acquired by the acquisition unit 212, the adjustment unit 213 adjusts the transfer parameter for each of the platforms (guests) 2-2 to 2-9. Each of the platforms (guests) 2-2 to 2-9 includes the reception unit 214 and the execution unit 215. The reception unit 214 receives data from the platform (host) 2-1 over the bus 3. Based on the data received by the reception unit 214, the execution unit 215 executes the processing requested by the data. The platform (host) 2-1 repeatedly executes the above-described processing until the processing times become uniform among the platforms (guests) 2-2 to 2-9. That is, the platform (host) 2-1 repeatedly executes the above-described processing until there is no wasted time in data transfer. Therefore, the platform (host) 2-1 can efficiently transfer data to the platforms (guests) 2-2 to 2-9.

In the above-described embodiment, PCIe is used as an example of a bus (for example, an expansion bus) or an input/output (I/O) interface in each component. The bus or the I/O interface is not limited to PCIe. For example, the bus or the I/O interface in each component may be a technique that enables transferring data between a device (peripheral controller) and a processor over a data transfer bus. The data transfer bus may be a universal bus that enables high-speed data transfer in a local environment (for example, a single system or a single apparatus) provided in a single housing or the like. The I/O interface may be a parallel interface or a serial interface.

In the case of serial transfer, the I/O interface preferably has a configuration that enables point-to-point connection and enables packet-based transfer of data. In the case of serial transfer, the I/O interface preferably has a plurality of lanes. The layer structure of the I/O interface may have a transaction layer for generating and decoding packets, a data link layer for error detection and the like, and a physical layer for conversion between serial and parallel data. Furthermore, the I/O interface may include a root complex positioned at the top layer and having one or a plurality of ports, an end point serving as an I/O device, a switch for increasing the number of ports, and a bridge that performs conversion between protocols. The I/O interface may use a multiplexer to multiplex data and a clock signal before the data and the clock signal are transmitted. In this case, a receiving device may use a demultiplexer to separate the data and the clock signal from each other.

What is claimed is:

1. An information processing apparatus connected to processing apparatuses over a bus, the information processing apparatus comprising:
a memory; and
a hardware processor coupled to the memory and:
individually transfers data to the processing apparatuses over the bus based on transfer parameters for transfer, each of the transfer parameters is set for each of the processing apparatuses;
acquires respective processing results of processing executed based on the data by the processing apparatuses; and
adjusts, for each of the processing apparatuses, the transfer parameter based on the corresponding processing result.

2. The information processing apparatus according to claim 1, wherein the hardware processor further: carries out, for each of the processing apparatuses, the adjustment of the transfer parameter based on a difference between the corresponding processing result and a target value for the corresponding processing result.

3. The information processing apparatus according to claim 1, wherein the hardware processor further: adjusts, for each of the processing apparatuses, one or more parameters included in the transfer parameter.

4. The information processing apparatus according to claim 1, wherein the hardware processor further:
acquires a processing result representing that processing has not been able to be executed due to change in the transfer parameter; and
carries out, for each of the processing apparatuses, the adjustment of the transfer parameter based on the acquired processing result.

5. An information processing system comprising:
an information processing apparatus; and
processing apparatuses connected to the information processing apparatus over a bus, wherein
the information processing apparatus includes:
a memory; and
a hardware processor coupled to the memory and:
individually transfers data to the processing apparatuses over the bus based on transfer parameters for transfer, each of the transfer parameters is set for each of the processing apparatuses;
acquires respective processing results of processing executed based on the data by the processing apparatuses; and
adjusts, for each of the processing apparatuses, the transfer parameter based on the corresponding processing result, and
each of the processing apparatuses includes:
a memory; and
a hardware processor coupled to the memory and:
receives the data from the information processing apparatus over the bus; and
executes, based on the received data, processing requested by the received data.
